(19) United States
(12) Patent Application Publication
(10) Pub. No.: US 2026/0080651 A1
(43) Pub. Date: Mar. 19, 2026

(54) Using Trusted Scans to Initiate a Model Update

(71) Applicant: Zebra Technologies Corporation, Lincolnshire, IL (US)

(72) Inventors: Darran Michael Handshaw, Sound Beach, NY (US); Edward Barkan, Miller Place, NY (US); Yuri Astvatsaturov, Lake Forest, IL (US); Andrea Mirabile, London (GB)

(21) Appl. No.: 18/759,679

(22) Filed: Sep. 16, 2024

(51) Int. Cl. G06V 10/25; G06F 16/587

(52) U.S. Cl. CPC G06V 10/25; G06F 16/587

(57) ABSTRACT

Devices, systems, and methods for using trusted scans to initiate a model update are provided. A data capture device may capture images of an unidentified object, and generate a payload based upon analysis of the captured images. The payload includes an object identifier corresponding to an object a model is configured to identify, and an indication the payload authorized or not authorized. The data capture device transmits the payload to a computing device. Responsive to the payload indicating the payload is authorized, the computing device performs a model update operation, and responsive to the payload indicating the payload is not authorized, the computing device refrains from performing the model update operation.

### BACKGROUND

A model, such as image recognition model for identifying an item based on features or other visual aspects of the item, generally requires updating when changes are made to the physical appearance of the item, as the changes may prevent or degrade the ability of the model to successfully identify the item. For example, features of an item's packaging such as colors, images, and/or text used to identify the item by the model may no longer be present on updated packaging. Thus, images of the item with updated packaging can be used to update the model's ability to identify the item with updated packaging.

Conventional retail checkout systems may identify an item scanned during checkout by capturing and providing images of the item to a model, such as an image recognition model. The checkout system may also identify the item based upon decoding the item's barcode scanned or otherwise captured during checkout. In such systems, identifying the item based upon the barcode, but failing to identify the item based upon the item images (e.g., due to a packaging update) may cause the system to determine that ticket-switching is taking place. Ticket-switching involves a perpetrator replacing the barcode on an item with a barcode from cheaper item, so that during checkout when the barcode is scanned, the checkout system charges for the lower priced item associated with the scanned barcode when a more expensive item is actually attached to the barcode. When ticket-switching occurs, the item associated with the barcode does not correspond to the item in images captured during checkout. For example, when placing the barcode for a pack of gum on a mobile phone, during checkout the system would identify the item as gum based on the scanned barcode that corresponds to gum, but would not recognize images of the mobile phone as a pack of gum. As such, the system would detect that the item associated with the scanned barcode (e.g., the inexpensive pack of gum) is not the item in images (e.g., of the mobile phone) captured during checkout. However, during checkout a mismatch between the item associated with the barcode and the item in the images would likewise occur when packaging for the item is updated such that the model cannot identify the item, as just explained.

Incorrectly attributing the scan of an item with updated packaging as ticket-switching can require the assistance of retail staff to resolve, inconvenience the customer, and require additional scans of the item wasting resources of the checkout system (e.g., power, processing cycles, memory, network resources), among other things. Accordingly, improved retail systems are needed that can update a model to identify items which are unidentified due to updated packaging in a seamless, automated fashion in order to minimize falsely identified ticket-switching events.

As such, devices, systems, and methods that can determine when an unidentified item scanned during checkout is caused by updated packaging of the item rather than ticket-switching, and moreover use the images of the item with updated packaging captured during checkout to update the model, may reduce or eliminate the aforementioned deleterious effects otherwise caused by scanning an item with updated packaging during checkout.

### SUMMARY

In an embodiment, the present disclosure discloses a method for generating an authorized payload to update a model configured to identify at least one object. The method may include: (i) capturing, by a data capture device, one or more images comprising image data of an unidentified object within a field of view of the data capture device, wherein the at least one object the model is configured to identify with a predetermined level of confidence does not include the unidentified object; (ii) generating, based on analyzing the image data, a payload including: (a) image associated data including a representation of at least a portion of the unidentified object, (b) an object identifier corresponding to an object of the at least one object the model is configured to identify, and (c) an indication the payload is at least one of authorized or not authorized; (iii) responsive to the payload being authorized, perform a model update operation; and (iv) responsive to the payload not being authorized, refrain from performing the model update operation.

In a variation of the embodiment, the object identifier is based upon one or more of an electronic identifier or a visual identifier included in at least the portion of image.

In another variation of the embodiment, the indication the payload is authorized is based upon one or more of: the data capture device, a location of data capture device, an operation of the data capture device, a user of the data capture device, a user input at the data capture device, or an authorization element in the image associated data.

In yet another variation of the embodiment, the model update operation includes one or more of: storing at least a portion of the image associated data on a memory as model update data, updating the model using at least the portion of the image associated data to identify the unidentified object as the object corresponding to the object identifier, creating an association between the object identifier and the image data and/or image associated data, or refraining from performing for at least a portion of time one or more operations associated with ticket-switching that is triggered by subsequent payload associated with the unidentified object.

In still yet another variation of the embodiment, the payload includes one or more of: a feature of the unidentified object or a feature of the object corresponding to the object identifier.

In a variation of the embodiment, the unidentified object is one object, of the at least one object, the model is configured to identify, with updated packaging.

In another variation of the embodiment, the method may include determining a region of interest in the one or more images and cropping the one or more images to include the region of interest.

In yet another variation of the embodiment, the method may include (i) receiving information indicating the payload is not authorized; (ii) responsive to receiving the information, generating information to authorize the payload; and (iii) providing, to a computing device, the information to authorize the payload.

In still yet another variation of the embodiment, receiving the information is responsive to the model determining, based upon the payload, that the unidentified object is not identified as the object corresponding to the object identifier.

In a variation of the embodiment, the method may include (i) capturing, by the data capture device, one or more additional images of the unidentified object; (ii) generating a second payload based upon the one or more additional images; and (iii) based upon the second payload and previously receiving the authorized payload associated with the unidentified object, perform the model update operation.

In another variation of the embodiment, the model may be further configured to, responsive to determining second image associated data in the second payload does not include one or more features of the unidentified object previously identified by the model in the authorized payload, refrain from performing the model update operation.

In yet another variation of the embodiment, the method may include, responsive to performing the model update operation based upon the authorized payload, capturing, by the data capture device, supplemental image data of the unidentified object used to perform a subsequent model update operation.

In another embodiment, the present disclosure discloses a system for generating an authorized payload to update a model configured to identify at least one object. The system may include: a data capture device having a field of view and configured to capture one or more images of the field of view; one or more processors; and a memory storing instructions that, when executed by the one or more processors, cause the one or more processors to: (i) capture the one or more images comprising image data of an unidentified object within the field of view, wherein the at least one object the model is configured to identify with a predetermined level of confidence does not include the unidentified object; (ii) generate, based on analyzing the image data, a payload including: (a) image associated data including a representation of at least a portion of the unidentified object, (b) an object identifier corresponding to an object, of the at least one object the model is configured to identify, and (c) an indication the payload is at least one of authorized or not authorized; (iii) responsive to the payload being authorized, perform a model update operation; and (iv) responsive to the payload not being authorized, refrain from performing the model update operation.

In yet another embodiment, the present disclosure discloses a method for updating a model based upon an authorized payload. The method may include: (i) receiving a payload including: (a) image associated data including a representation of at least a portion of an unidentified object, the image associated data generated based upon image data captured by a data capture device, (b) an object identifier corresponding to an object, of one or more objects, the model is configured to identify, and (c) an indication the payload is at least one of authorized or not authorized; (ii) responsive to the payload indicating the payload is authorized, performing a model update operation; and (iii) responsive to the payload indicating the payload is not authorized, refraining from performing the model update operation.

In a variation of the embodiment of the method, the object identifier may be based upon one or more of an electronic identifier or a visual identifier included in at least the portion of image.

In another variation of the embodiment of the method, the indication the payload is authorized is based upon one or more of: a data capture device, a location of data capture device, an operation of the data capture device, a user of the data capture device, a user input at the data capture device, or an authorization element in the image associated data.

In yet another variation of the embodiment of the method, the model update operation includes one or more of: storing at least a portion of the image associated data on a memory as model update data, updating the model using at least the portion of the image associated data to identify the unidentified object as the object corresponding to the object identifier, creating an association between the object identifier and the image data and/or image associated data, or refraining from performing for at least a portion of time one or more operations associated with ticket-switching triggered by receiving a subsequent payload associated with the unidentified object.

In still yet another variation of the embodiment of the method, the unidentified object is an update of one object, of the one or more objects, the model is configured to identify, and the method may further include updating the model to identify the unidentified object and the one object.

In a variation of the embodiment, the unidentified object may be an update of one object, of the one or more objects, the model is configured to identify, and the update of the one object may include updated packaging.

In another variation of the embodiment, the method may further include (i) generating information indicating the payload is not authorized; (ii) providing the information to the data capture device; (iii) receiving, from the data capture device, information to authorize the payload; and (iv) authorizing the payload.

In yet another variation of the embodiment, the method may further include providing the image associated data in the payload to the model; and determining, by the model based upon the image associated data in the payload, the unidentified object is not identified as the object corresponding to the object identifier,

In still yet another variation of the embodiment, the information indicating the payload is not authorized may be in response to determining the unidentified object is not identified as the object.

In a variation of the embodiment, the method may include receiving a second payload including second image associated data including a representation of at least the portion of the unidentified object; and responsive receiving to the second payload and previously receiving the authorized payload associated with the unidentified object, performing the model update operation using the second image associated data.

In another variation of the embodiment, the method may include responsive to the model determining the second image associated data in the second payload does not include one or more features of the unidentified object previously identified by the model in the authorized payload, refraining from performing the model update operation.

In yet another variation of the embodiment, the method may include responsive to performing the model update operation based upon receiving the authorized payload, receiving supplemental image associated data including a representation of at least the portion of the unidentified object; and performing one or more of: storing the supplemental image associated data as model update data, or updating the model using the supplemental image associated data.

In still yet another variation of the embodiment, a first computing device updates the model, and a second computing device operates the model; or a first computing device updates the model and operates the model.

In still yet another embodiment, the present disclosure discloses a system for updating a model based upon an authorized payload. The system may include one or more processors; and a memory storing instructions that, when executed by the one or more processors, cause the one or more processors to: (i) receive a payload including: (a) image associated data including a representation of at least a portion of an unidentified object, the image associated data generated based upon image data captured by a data capture device including at least one image of at least a portion of an unidentified object, (b) an object identifier corresponding to an object, of one or more objects, the model is configured to identify, and (c) an indication the payload is at least one of authorized or not authorized; (ii) responsive to the payload indicating the payload is authorized, perform a model update operation; and (iii) responsive to the payload indicating the payload is not authorized, refrain from performing the model update operation.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A is a perspective view of an example data capture device, in accordance with embodiments disclosed herein.

FIG. 1B is a perspective view of another example data capture device, according to embodiments.

FIG. 2A is a block diagram of an example computing environment for generating and/or using an authorized payload to update a model, according to embodiments.

FIG. 2B is a block diagram of an example process for updating a model, according to embodiments.

FIG. 2C is a block diagram of an example signal diagram for updating the model 230, according to embodiments.

FIG. 3A is a block diagram for generating an example authorized payload to update a model, according to embodiments.

FIG. 3B is a block diagram of an example updated packaging that has not been stored within the model, according to embodiments.

FIG. 4A is a flow diagram of an example method for generating an authorized payload to update a model configured to identify at least one object, according to some embodiments

FIG. 4B is a flow diagram of an example method for updating a model based upon an authorized payload, according to some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As previously described, conventional retail checkout systems that incorrectly attribute the scan of an item with updated packaging as ticket-switching require the assistance of retail staff to resolve, inconvenience the customer, and require additional scans of the item wasting resources of the checkout system (e.g., power, processing cycles, memory, network resources), among other things. Accordingly, improved systems, methods, and devices are disclosed that can update a model using a trusted payload to identify items which are unidentified due to updated packaging in a seamless, automated fashion in order to minimize falsely identified ticket-switching events.

As used here, “unidentified object” refers to an object with new/updated packaging, where the model has not been configured to identify an object having such packaging as a particular object (e.g., the particular object associated with the barcode on the updated packaging) with a certain level of confidence. The new/updated packaging may include a new/updated label on the object (e.g., updated text, color, graphics) and/or updated packaging dimensions for the object (e.g., promotional packaging to hold 20% more of the product). In at least some aspects, the new/updated packaging may refer to, or include, a new/updated weight for the object, as weight may be used as a secondary means of identifying the object.

A data capture device captures images of an unidentified object, and generates a payload based upon analyzing the captured images. The payload includes an object identifier corresponding to an object a model is configured to identify, and an indication the payload authorized or not authorized. The data capture device transmits the payload to a computing device, such as a server. Responsive to the payload indicating the payload is authorized, the computing device performs a model update operation, and responsive to the payload indicating the payload is not authorized, the computing device refrains from performing the model update operation. Using authorized payloads to update the model reduces or altogether eliminates the need to scan an unidentified object more than once. This in-turn reduces resource consumption of the devices and over system by reducing power, memory, processing cycles, and network resources required to rescan the item or resolve ticket-switching events, including but not limited to power to operate imaging devices, data capture devices, servers, and/or network equipment; memory to generate, store and/or transmit captured images and payloads associated scanned items; processing cycles of processors to process the payload, operate a model; and/or network resources to transmit the captured images and payloads, to name but a few.

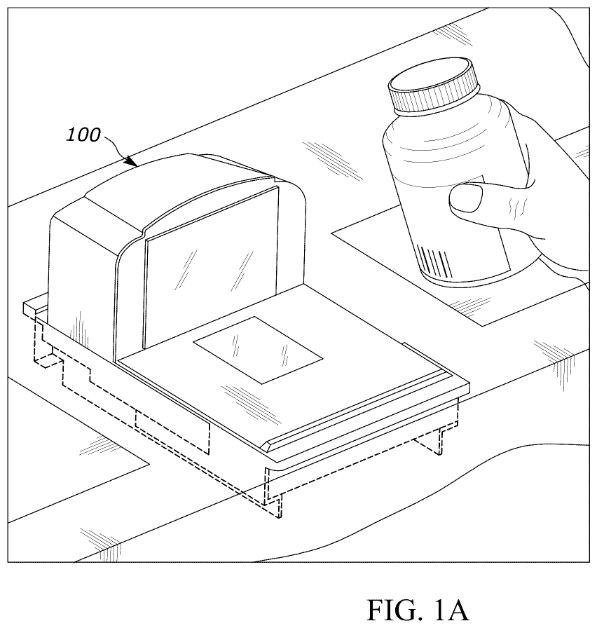

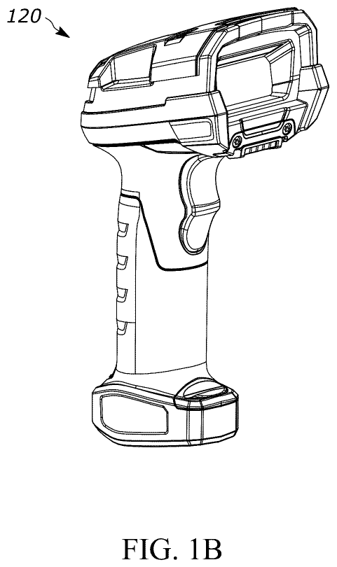

Turning to the Figures, FIGS. 1A and 1B each illustrate example data capture devices configured to generate an authorized payload. FIG. 1A is a perspective view of a bioptic indicia reader 100 data capture device. The bioptic indicia reader 100 may be configured to capture one or more images of an object passed across the field of view of its imaging assembly. The one or more images may be used to decode indicia or perform vision operations like object detection and recognition. FIG. 1B illustrates an example handheld indicia reader 120 data capture device which may be configured to similarly capture one or more images of its field of view, e.g., for indicia decoding and/or object recognition. In other embodiments, the data capture device may be a handheld computer (e.g., a tablet or otherwise portable computing device having an imager to capture one or more images of an object). While it will be appreciated that devices, systems, and methods disclosed may include, and/or be used in connection with, the data capture devices 100, 120 described above, this should not be considered limiting, and it should be understood that other form factors of indicia readers, and/or other data capture devices, may correspond to, encapsulate, and/or otherwise be associated with, the disclosed techniques.

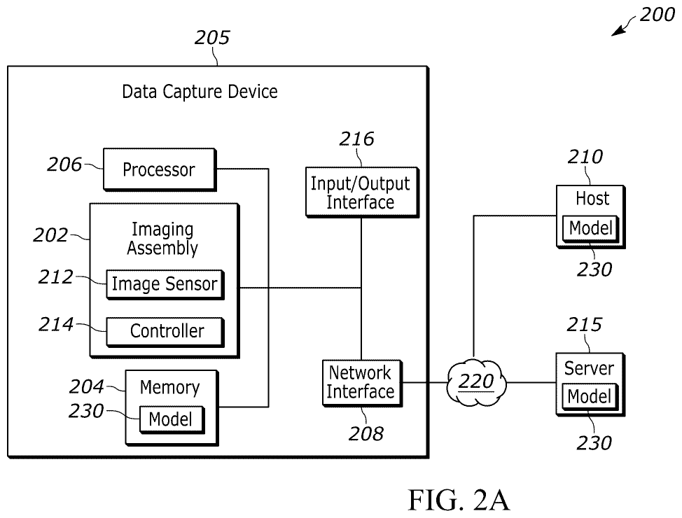

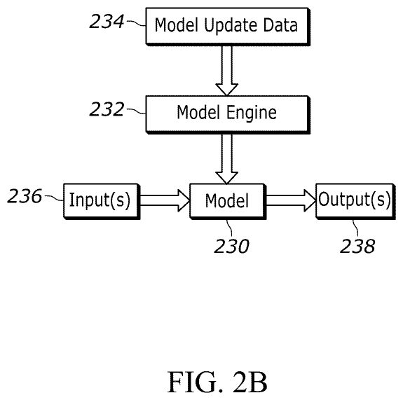

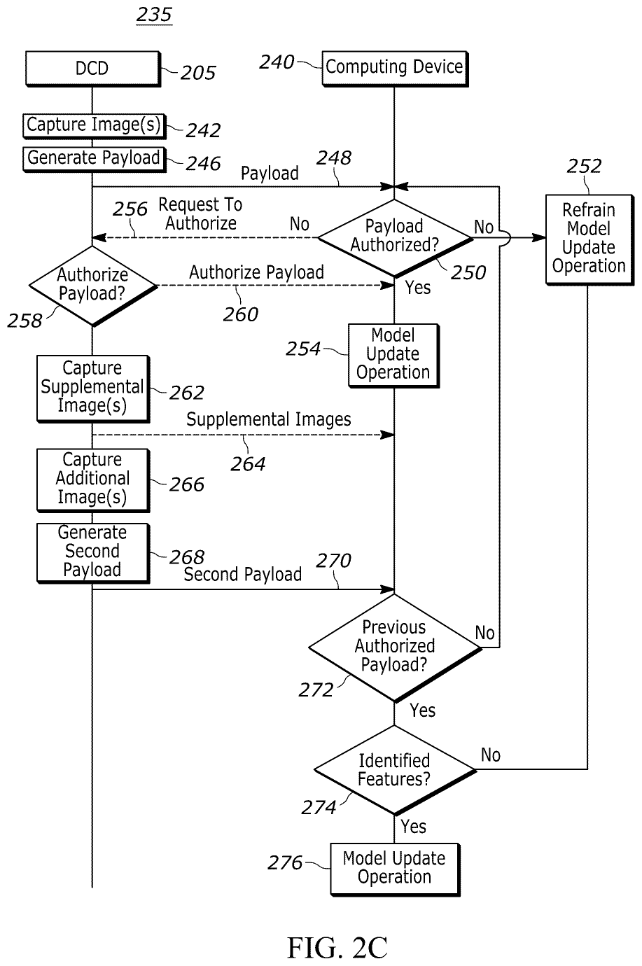

FIG. 2A illustrates a block diagram of an example computing environment 200 for generating and/or using an authorized payload to update a model, according to embodiments. The computing environment 200 may include computing devices such as a data capture device 205, a host 210 and a server 215 connected by a network 220. Although the computing environment 200 is shown to include one data capture device 205, one host 210, one server 215, and one network 220, it should be understood that the computing environment 200 may include additional, fewer, and/or alternate components, and may be configured to perform additional, fewer, or alternate actions, including components/actions described herein. Similarly, while the computing devices 205, 210, 215 are shown to include certain components, it should likewise be understood that the computing devices 205, 210, 215 may include additional, fewer, and/or alternate components, and also may be configured to perform additional, fewer, and/or alternate actions, including the components and/or actions described herein. For example, the computing environment 200 may include a plurality of data capture devices 205, all of which may be interconnected via the network 220. Similarly, the data capture device 205 may include multiple processors 206, and may not include an I/O interface 216. Moreover, various aspects of the computing environment 200 may include any suitable additional component(s) not shown in FIG. 2A, and/or omit component(s) shown in FIG. 2A, such as but not limited to the exemplary components described herein. Furthermore, it should be appreciated that additional and/or alternative connections between components shown in FIG. 2A may be implemented. As just one example, the data capture device 205 and the host 210 may be connected via a direct communication link (not shown in FIG. 2A) instead of, or in addition to, via the network 220.

The data capture device 205 may include an imaging assembly 202, a memory 204, a processor 206, a network interface 208, and an I/O interface 216, any and/or all of which may be interconnected via an address/data bus or otherwise communicatively connected.

The imaging assembly 202, such as the imaging assembly of indicia readers 100, 120, may include at least one image sensor 212 and a controller 214. In particular, the at least one image sensor 212 may be configured to capture image data comprising one or more images of a field of view (FOV), e.g., a FOV including a target object. The at least one image sensor 212 may be and/or include a charge-coupled device (CCD) sensor, a complementary metal-oxide semiconductor (CMOS) sensor, a one-dimensional array of addressable image sensors, a two-dimensional array of addressable image sensors, a monochrome sensor, a color sensor, and/or any other suitable image sensor. Depending on the implementation, the at least one image sensor 212 may include a color sensor such as a vision camera in addition to and/or as an alternative to the monochrome sensor. The imaging assembly 202 may include one or more subcomponents, such as one or more controllers 214 to control and/or perform operations of the imaging assembly 202. The controller 214, the processor 206, and/or other suitable component may be configured to control the imaging assembly 202.

The imaging assembly 202 may be configured to capture image data which may comprise one or more images (e.g., two-dimensional images) of a target object within the FOV, including, for example, packages, items, labels, and/or other target objects that may or may not include indicia, such as a barcode, a QR codes, a digital watermark detectable by an imager (e.g., a digital watermark substantially invisible to a human eye), and/or other such indicia of target objects, which some examples includes merchandise available at retail/wholesale store, facility, or the like. The controller 214, the processor 206, a model 230, the host 210, the server 215, and/or other suitable component(s) of the example computing environment 200 may thereafter analyze the captured image data of target objects and/or indicia passing through a field of view of the imaging assembly 202, e.g., for indicia decoding, object recognition/identification, or any other suitable purpose.

The data capture device 205 may include a memory 204 accessible by the processor 206 (e.g., via a memory controller), the imaging assembly 202 (e.g., via controller 214), and/or other components of the data capture device 205 and/or computing environment 200. The memory 204 may include one or more suitable storage media such as a magnetic storage device, a solid-state drive, random access memory, volatile memory, non-volatile memory, a database, and/or any other suitable memory. The memory 204 may be a local memory included within the housing of the data capture device 205. The memory 204 may contain instructions which may be executed by the processor 206. The instructions may include software applications, algorithms, modules, decoders, models (e.g., machine learning models), images for updating models, and/or other suitable instructions.

The memory 204 may include the model 230, such as a machine learning model. In at least some implementations, the model 230 may be configured to receive image data including one of more images (e.g., images of indicia and/or objects captured by the data capture device 205), and identify (also referred to herein as recognize) objects within the image data. The model 230 may be configured to perform other functions (e.g., decoding of an indicia in the image data). The model 230 may be updated, also referred to at times as training, retraining, and/or fine-tuning, especially in the context of a machine learning model. For example, in the context of using the model to identify items in a retail store at checkout, the model 230 may be updated to identify an unidentified item the retail store has never carried before, or identify an item with updated packaging (e.g., a new shape of the existing item, updated labeling, etc.) the model 230 is not configured to identify. To update the model 230, the computing device updating the model 230, such as the data capture device 205, host 210, and/or server 215, may use images of the unidentified object, or otherwise data as further described below with respect to FIG. 2B. Other devices of the computing environment 200 may store, configure, update, and/or operate the model 230, such as the host 210 and/or the server 215. For example, in some implementations, the sever 215 may update and store the model 230 in a memory of the server (e.g., the memory 204), and the data capture device 205 and/or host 210 may retrieve the updated model 230 from the server 215 via the network 220 for execution locally on the data capture device 205 and/or host 210 respectively. In other implementations, the host 210 may update the model 230, store the updated model 230 in a memory of the host 210 (e.g., the memory 204), and execute the model 230. It will be understood that the computing environment 200 may be configured to configure, update, store, and/or operate the model 230 via any suitable component of the computing environment 200.

The processor 206 may include one or more processors such as a microprocessor (μP), microcontroller, central processing units (CPU) and/or graphics processing unit (GPU) and/or any suitable type of processor. The processor 206 may include one or more logical processors (e.g., virtual execution unit(s) having one or more threads) and/or physical processors (e.g., hardware execution units having one or more cores) and may include multitasking and/or parallel processing. In at least some embodiments, the processor 206 may be configured to control the imaging assembly 202, and/or overall operations of the data capture device 205.

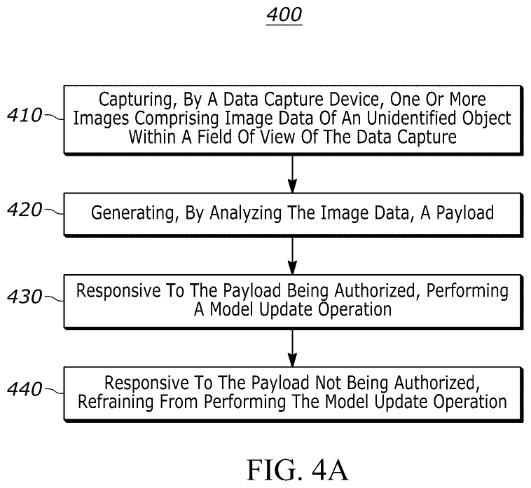

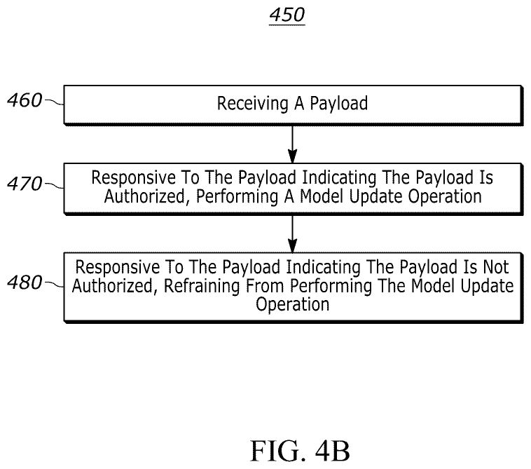

The processor 206 may interact with the memory 204 to obtain, for example, machine-readable instructions stored in the memory 204 corresponding to, for example, the operations represented by the example signal diagram 235 of FIG. 2C and/or the example methods 400 and 450 of FIGS. 4A and 4B respectively. The processor 206 may also interact with the memory 204 to obtain, or store, data and/or instructions related to the imaging assembly 202, the model 230, and/or other component(s) of the computing environment 200. Additionally, or alternatively, machine-readable instructions corresponding to the example operations described herein may be stored on one or more removable media (e.g., a compact disc, a digital versatile disc, removable flash memory, etc.) that may be communicatively coupled to the data capture device 205 to provide access to the machine-readable instructions stored thereon. In particular, the instructions stored in the memory 204, when executed by the processor 206, may cause the processor 206 to receive and analyze data (e.g., image data) and signals generated by the imaging assembly 202. For example, the memory 204 may include one or more programs, algorithms, models, modules, and the like which may analyze the captured image data to generate an associated payload.

The data capture device 205 of FIG. 2A may include a network interface 208 to enable communication by the data capture device 205 with other machines via, for example, the network 220. The example network interface 208 may include any suitable type of communication interface(s) (e.g., wired and/or wireless interfaces) and be configured to operate in accordance with any suitable protocol(s). For example, in some embodiments, network interface 208 may transmit data or information (e.g., image data, payloads, etc.) between remote processor(s) and/or a remote server, such as host 210, server 215, and/or other components of the data capture device 205 or computing environment 200.

The example data capture device 205 of FIG. 2A may also include input/output (I/O) interface 216 to enable receipt of input (e.g., user input via a user interface) and/or communication of output data (e.g., to a user of the data capture device 205). For example, the user may provide input to the data capture device 205 via I/O to indicate the payload the data capture device 205 generates is authorized.

The example computing environment 200 of FIG. 2A may include at least one communication and/or data network 220 to communicatively couple components of the computing environment 200, such as the data capture device 205, the host 210, the server 215 and/or any other suitable device/component, via one or more communication interfaces, such as the network interface 208. The network 220 may comprise any suitable network or networks, including a local area network (LAN), wide area network (WAN), Internet, or combination thereof. For example, the network 220 may include a wireless cellular service (e.g., 4G, 5G, etc.). Generally, the network 220 enables bidirectional communication between components of the computing environment 200. In one aspect, the network 220 may comprise a cellular base station, such as cell tower(s), communicating to the one or more components of the computing environment 200 via wired/wireless communications based on any one or more of various mobile phone standards, including NMT, GSM, CDMA, UMMTS, LTE, 5G, or the like. Additionally, or alternatively, the network 220 may comprise one or more wired and/or wireless data buses, modems, routers, switches, or other such connection points communicating to the components of the computing environment 200, which may include wired and/or wireless communications based on any one or more of various standards, including by non-limiting example, IEEE standards (e.g., 802.3, 802.11b/g/n/ac/ax, etc.), Bluetooth, and/or the like.

The example computing environment 200 of FIG. 2A may also include a host 210. In at least some implementations, the host may be, or include, a point-of-sale (POS) device used for purchasing retail items. The host 210 may be configured to receive image data, a payload, model update data (e.g., image data) from the data capture device 205 and/or server 215 via the network 220, and/or any other suitable data. In some implementations, the host 210 may include a memory to store the model 230 and/or data to update the model. The host 210 may be configured to update the model 230 and/or operate the model 230, as further described herein.

The example computing environment 200 of FIG. 2A may also include a server 215. The server 215 may include one server or multiple servers, which may be arranged as a network of multiple servers, a bank of multiple servers, etc. The server 215 may implemented at least partially on an on-premise or local computing environment, a multi-cloud computing environment, a public cloud computing environment, a private cloud computing environment, and/or a hybrid cloud computing environment (e.g., Alibaba Cloud, Amazon Web Services (AWS), Google Cloud, IBM Cloud, Microsoft Azure, etc.). In an example arrangement, the server 215 may be implemented as, or on a part of, a cloud computing environment, or may otherwise communicate with other hardware or software components within one or more cloud computing environments to send, retrieve, or otherwise analyze data or information described herein. For example, in some arrangements, the data capture device 205 may be communicatively coupled via network 220 to the server 215. In at least some implementations, the server 215 may be or include the host 210 (e.g., a POS device), and vice versa. In some implementations, the server 215 may include a memory to store the model 230 and/or data to update the model 230. The sever 215 may be configured to update the model 230 and/or operate the model 230, as further described herein.

As previously described, the model 230 may reside on the data capture device 205, the host 210, the server 215, or a combination thereof. In some embodiments, the model 230 is a local model on an individual device (e.g., the data capture device 205, the server 215, the host 210). In such embodiments, once the individual device updates the model 230 (or the local model is otherwise updated), the updated model 230 may be provided to one or more other authorized devices. In one aspect, the updated model 230 may be transmitted to devices communicatively coupled to the network 220 (e.g., devices on a local network, a wide area network, a remote network). In another aspect, the updated model 230 may be stored in a repository (e.g., a memory, a database, a cloud server) accessible to other devices which receive the updated model 230 from the repository. For example, a retailer in Chicago updates a local copy of the model 230 on the data capture device 205 to identify a bottle of detergent with new packaging. The data capture device 205 (or other suitable device) in Chicago then transmits the updated model 230 to authorized data capture devices 205 at the retailer's New York City location. Accordingly, the authorized data capture devices 205 in New York City location may identify the bottle of detergent with new packaging using the updated model 230 from Chicago without having to update each local copy of the model 230 on each authorized data capture device 205 in the New York City location.

FIG. 2B depicts a block diagram of an example process for updating the model 230, such as a machine leaning model. Other processes and/or methods may be used to update the model 230. Some of the blocks in FIG. 2B may represent and/or include hardware and/or software components, data structures or memory storing these data structures, registers, or state variables, and/or input and/or output data. Input and/or output signals may be represented by arrows labeled with corresponding signal names. One or more computing devices of the computing environment 200, such as the data capture device 205, the host 210, and/or the server 215, may be configured to update and/or operate the model 230.

In at least some implementations, a model engine 232 may be used to update the model 230. The model engine 232 may apply at least one of a plurality of methods and algorithms to update the model 230, which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. The model updating methods and algorithms may be directed toward at least one of a plurality of categorizations, such as supervised learning, unsupervised learning, and reinforcement learning. In one aspect, the algorithms may be included as a library or package executed on the computing device updating and/or training the model. For example, libraries may include the TensorFlow based library, the PyTorch library, and/or the scikit-learn Python library.

The model engine 232 may comprise a set of computer-executable instructions implementing model loading, configuration, initialization and/or operation functionality. The model engine 232 may include instructions for storing updated models (e.g., in a memory communicatively connected to the computing environment 200 and/or computing device 205, 210, 215).

The model engine 232 may access a data source (e.g., a memory, a database, etc.) for model update data 234 suitable to generate and/or update the model 230. The model update data 234 may be image data (e.g., of objects) or other suitable data with assigned relevant and comprehensive labels (classes or tags) used to fit the parameters (weights) of the model 230 with the goal of updating it by example. In some implementations, once an appropriate model 230 is updated and validated to provide accurate predictions and/or responses, the updated model 230 may be loaded at runtime (e.g., by the data capture device 205, the host 210, the server 215) to process input data and generate output data. In come implementations, the model engine 232 may update and/or otherwise alter the existing model 230, such as updating the model 230 to identify unidentified items and/or updated packaging.

To update the model 230, the model engine 232 may use the model update data 234. The computing device updating the model 230 may obtain and/or have available one or more types of model update data 234 (e.g., image data included in a payload). In at least some aspects, the model update data 234 may include images of objects, such as images of objects captured by the data capture device 205 during the scan of an updated item, and/or any other suitable model update data. In one aspect, the model engine 232 may process and/or analyze the model update data 234 to update the model 230 to recognize and/or identify the objects contained in the images of the model update data 234.

Once updated, the model 230 may perform operations on one or more data inputs 236 to produce a desired data output 238. In some implementations, the model 230 may be loaded by a computing device at runtime from a memory (e.g., the memory 204) to process the input data 236. The input data 236 may include one or more images of unidentified objects captured by the data capture device 205 (e.g., image data included in a payload), or another suitable device. For example, the server 215 may receive image data captured by the data capture device 205 via the network 220. In response to receiving the image data, the server 215 may load the model 230 to process the image data, and provide as the output 238 an identification of one or more objects appearing in the images of the image data.

The model update data 234 may be updated at one or more times, e.g., by one or more computing devices 205, 210, 215 of the computing environment 200, to include updated image data contained within a payload. For example, and as previously described, the model 230 may be updated to recognize items purchased during checkout. The packaging of an item recognizable to the model may be updated, such that the model 230 is unable to identify the item with the updated packaging. One or more images of the item having the updated packaging may be used as model update data 234 to update the model 230 to identify and/or recognize the item having the updated packaging.

In some embodiments, the computing environment 200 may perform a model update operation (e.g., update the model 230) based upon an authorized payload. The data capture device 205 may capture and analyze one or more images of an object within its FOV, e.g., an unidentified object the model 230 is not configured to identify with a predetermined level of confidence. The data capture device 205 may be configured to generate the authorized payload including data derived from the image data (i.e., an identifier such as a barcode, data associated with the image data of the object, etc.), among other things.

FIG. 2C depicts an example signal diagram 235 for updating the model 230, according to some embodiments. The signal diagram 235 includes the data capture device 205, and a computing device 240 (e.g., the host 210, the server 215). In at least some implementations, the data capture device 205 may also be the computing device 240, for example when the data capture device 205 is configured to both operate and update the model 230.

The data capture device 205 may capture one or more images 242 comprising image data of an unidentified object within the FOV of the data capture device 205. The unidentified object may not be an object the model 230 is configured to identify with a predetermined level of confidence. The data capture device 205 may analyze (e.g., via the processor 206) the image data to generate a payload 246. The payload may include at least a portion of the image data including a representation of at least a portion of the unidentified object. For example, the data capture device 205 may capture multiple images and include only a subset of images (e.g., images in which the unidentified object is most visible) in the payload, may crop one or more images around a region of interest (e.g., around features of the unidentified object, such as an indicia affixed to the unidentified object) and include the cropped images in the payload, may down sample the images to provide images of the unidentified object at a lower resolution than the original images, etc.

The payload may include an object identifier corresponding to an object the model is already configured to identify. The object identifier may be based upon an electronic identifier (e.g., an RFID tag on the unidentified item), a visual identifier (e.g., a barcode, a GS 1 datalink, a digital watermark substantially invisible to a human eye but detectable by an imager) in at least a portion of the image data, a Temptime® chemical marker, and/or any other suitable object identifier. The object identifier may be used by one or more devices (e.g., the data capture device 205, the host 210, the server 215) of the computing environment 200 to identify the unidentified object. For example, even if the model 230 does not recognize the unidentified object via images, the object identifier may provide an indication of what the unidentified object may be, as the object identifier is associated with an object the model 230 is already configured to identify.

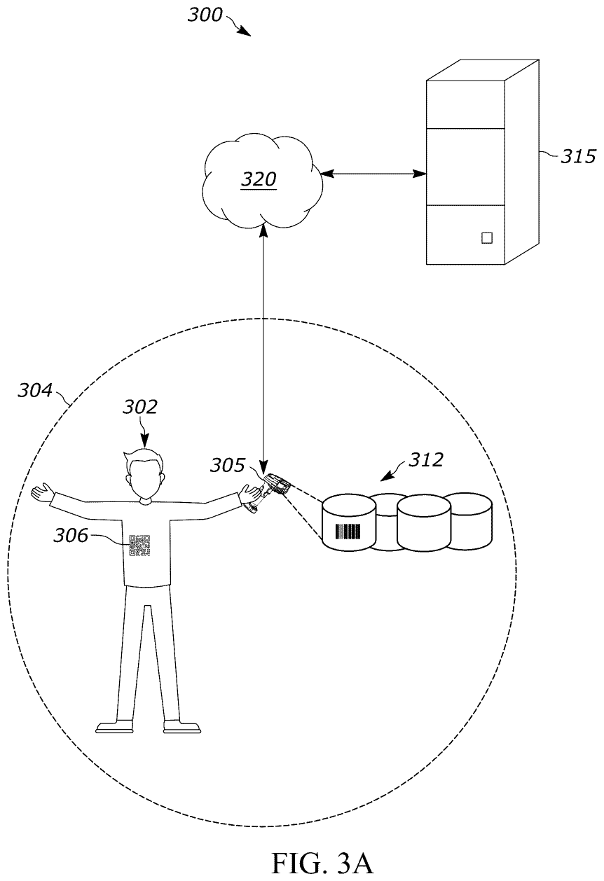

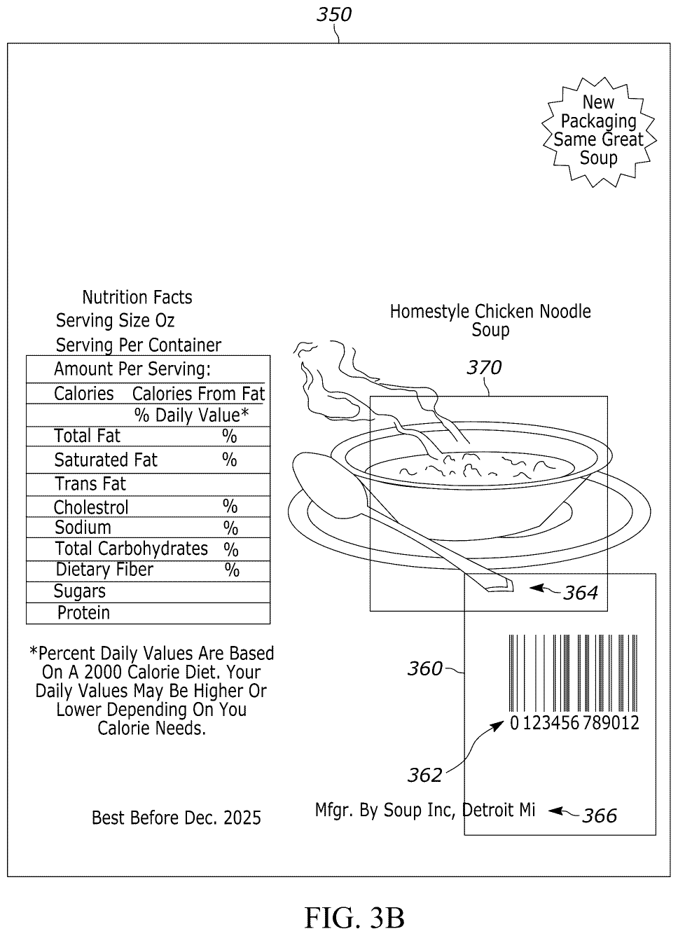

The payload may include an indication the payload is authorized or is not authorized. In at least some implementations, an authorized payload may indicate to the computing device 240 that the computing device 240 should perform a model update operation, and conversely an unauthorized payload may indicate the computing device 240 should not perform the model update operation. In at least some embodiments, the computing environment 200 is configured such that the server 215 (or other suitable device) performs a model update only if it receives an authorized payload, or it doesn't perform a model update only if sees an unauthorized payload. In this way, a lack of an authorization can also act as an indicator of whether the model update operation should be performed. The model update operation may include storing at least a portion of the image data on a memory as model update data 234 and/or using at least the portion of the image data to update the model 230 to identify the unidentified object as the object corresponding to the object identifier. In at least some implementations, the model update operation may include creating an association between the object identifier and the image data and/or image associated data. In at least some implementations, the model update operation may include learning an updated weight or updated dimensions for the object. In at least some implementations, the model update operation may include refraining (e.g., for some amount of time) from performing one or more operations associated with ticket-switching that is triggered by a subsequent payload associated with the unidentified object. For example, the computing device 240 or other suitable device may recognize from a payload the object identifier, but not recognize the unidentified object from the image data as corresponding to the object of the object identifier, which may be an indication of an occurrence of ticket-switching. However, this scenario may be due to the unidentified object being an object the model 230 is not yet configured to identify with a predetermined level of confidence, and is not due to ticket-switching. In some embodiments, the authorized payload would prevent the computing device 240 from performing operations (e.g., alerts, notifications) associated with ticket-switching when subsequent payloads associated with the unidentified object are received, as further described in the example of FIG. 3A. In some embodiments, the authorized payload may cause the computing environment 200 (e.g., 210) to ignore operations associated with ticket-switching

In some implementations, the data capture device 205 authorizes the payload based upon the configurations of the data capture device 205 generating the payload. In some aspects, the data capture device 205 is configured by way of configuration software. In such aspects, the data capture device 205 expected to be used by an employee or other trusted party (e.g., for stocking purposes) can be configured to generate authorized payloads upon a successful scan of an indicia associated with an item, or a successful capture of any other suitable identifier attached to, or otherwise associated with, the item. The configuration software may also configure other settings/parameters of the data capture device 205, such as operational parameters, causing the data capture device 205 to generate authorized payloads. For example, the data capture device 205 may be used for retail operations (e.g., checkout, inventory, etc.) by trusted employees. In such an example, the trusted employee would not be expected to, for example, perform ticket-switching. If the payload is a result of a ticket-switch, the payload may include images of an incorrect object used during ticket-switching that is not the unidentified object. Where such a payload is used as model update data 234 to update the model 230, the updated model 230 would be configured to associate the incorrect object as the unidentified object.

In some implementations, the payload may be authorized based upon the location of the data capture device 205. Referring again to aspects including configuration software for the data capture device 205, the configuration software may configure settings/parameters of the data capture device 205 based on location, such as geofencing (e.g., when the data capture device 205 is inside a geofence, it generates authorized payloads), a GPS location of the data capture device 205 (e.g., via a GPS module of the data capture device 205), through locationing techniques like triangulation or trilateration based on signal-generating nodes located within a venue in which the data capture device 205 is located, or any other suitable manner of locating the data capture device 205. In one aspect, locationing techniques may identify that a signature of the data capture device 205 (e.g., an electronic signature of the data capture device 205 that can be associated with a wireless radio thereof) is within detectable range of a node, beacon, access point, or other component capable of detecting a signature of the data capture device 205. For example, if an access point detects the data capture device 205 including a wireless radio as being within a range that covers an area where trusted scans are expected, then the data capture device 205 can generate authorized payloads based on being connected to the respective access point. In another example, the data capture device 205 that is located in the retailer's warehouse (e.g., a “trusted” location) may be used exclusively for inventory by trusted employees, such that payloads originating from the data capture device 205 in the trusted location would be authorized payloads.

In some implementations, the payload may be authorized based upon a user of the data capture device (e.g., a trusted employee logged into the data capture device 205 as just described). In such implementations, the payload authorization may be identified through a user input (e.g., at a host 210 such as a POS) that is transmitted to the data capture device 205 (e.g., via the network 220). In some implementations, the data capture device 210 includes a means to receive the user's input that causes the data capture device 205 to generate the authorized payload. In such implementations, the data capture device 205 receives the user input at a graphical user interface of the data capture device 205, via a barcode that is scanned by the data capture device 205 identifying the user, via an RFID tag that identifies the user and is within range of an RFID reader of data capture device 205, and/or any other suitable manner of providing user input to data capture device 205.

In some implementations, the payload may be authorized based upon an operation of the data capture device, e.g., when the data capture device 205 is operating in a mode in which it capture images of an item with updated packaging for the express purpose of updating the model to identify the item with the updated packaging.

In some implementations, the payload may be authorized based upon an authorization element. In some aspects, the authorization element is in at least the portion of image data, such as when the authorization element is a digital watermark that may be substantially invisible to a human eye but is detectable by an imager, and indicates the packaging of the unidentified object is updated packaging. In some aspects, the authorization may be an RFID tag used as an authorization element. For example, an RFID tag may be applied to a product having updated packaging.

The data capture device 205 may generate the payload 246 based on analyzing the captured images 242, and transmit 248 the payload to the computing device 240. The computing device 240 may determine 250 whether the payload is authorized, for example based upon the indication of authorization included in the payload (e.g., via analysis of the payload by the computing device 240). If the payload is not authorized, the computing device 240 may refrain from performing a model update operation 252. If the payload is authorized, the computing device 240 may perform the model update operation 254.

In at least some implementations in which the payload is not authorized, the computing device 240 may transmit a request 256 to the data capture device 205 to authorize the payload (e.g., data, an alert, a notification, or other suitable request). The request 256 can provide the user of the data capture device 205 an opportunity to authorize 258 the payload (e.g., to avoid the unauthorized payload from otherwise causing a ticket-switching operation or causing a model update operation to not be performed). If the user of the data capture device 205 does authorize the payload (e.g., via a user input at a user interface of the data capture device 205) based upon the request 256, the data capture device 256 may generate information to authorize the payload, and transmit 260 the information to authorize the payload to the computing device 240. In response to receipt of the transmission 260 authorizing the payload, the computing device 240 may perform the model update operation 254.

In at least some implementations, generating and/or transmitting the request 256 to authorize the payload is responsive to the model 230 of the computing device 240 determining, based upon at least one image of the unidentified object in the payload (e.g., in the image associated data of the payload), that the unidentified object is not identified as the object corresponding to the object identifier. In such an implementation, the computing device 240 provides the user of the data capture device 205 an opportunity to authorize the payload, e.g., to prevent the computing device 240 from otherwise determining a ticket-switching event may be occurring based upon determining a non-correspondence between the image(s) of the unidentified object in the payload and the object of the object identifier in the payload.

In some implementations, the data capture device 205 may capture one or more supplemental images 262 of the unidentified object in response to the model update operation(s) 254. The supplemental images may be used to perform a subsequent model update operation. In one example, the data capture device 205 may transmit 264 the supplemental images to the computing device 240 for use during a subsequent model update operation (e.g., to store the supplemental images as model update data 234, use the supplemental images to update the model, etc.).

In at least some implementations, the data capture device 205 may capture one or more additional images 266 of the unidentified object, for example during a subsequent scan of the unidentified object during a subsequent customer checkout. The data capture device 205 may generate a second payload 268 based upon the additional images similar to generating the first payload 246. The data capture device 205 may transmit 270 the second payload to the computing device 240. The computing device 240 may determine 272 whether it has previously received an authorized payload associated with the unidentified object. If the computing device 240 has previously received an authorized payload associated with the unidentified object, the computing device 240 may perform a model update operation 276. For example, previously receiving the authorized payload for the same unidentified object may indicate to the computing environment 200 that the subsequent scan of the item during the subsequent checkout is not a ticket-switching event when the object identifier does not correspond to the unidentified object in the additional images of the second payload. If the computing device 240 has not previously received an authorized payload associated with the unidentified object, the computing device 240 may decide whether the second payload is authorized 250, as previously described.

In at least some aspects, after the computing device 240 determines it has previously received an authorized payload associated with the unidentified object, the computing device 240 (e.g., via the model 230) may determine 274 whether the second associated image data in the second payload includes one or more features of the unidentified object previously identified by the model 230 in the previously received (e.g., first) authorized payload. For example, the image associated data previously received in the first authorized payload may include images having features of the unidentified object. The features may include images, characters, or other identifiable features of the unidentified object packaging and/or unidentified object. As the first payload containing the features is authorized (e.g., trusted), the features may be considered as representative and/or associated with the unidentified object. The second payload, for example, may not be an authorized payload. However, if the associated image data of the second payload contains one or more features of the unidentified object that are the same as the featured from the first authorized payload, the computing device 240 (e.g., via the model 230) may determine the unidentified object in the first payload is the same object as the unidentified object in the second payload. Accordingly, the second payload may be used to perform the model update operation 276 when determining the second image associated data in the second payload does include one or more features of the unidentified object previously identified by the model 230 in the authorized payload. Conversely, responsive to determining second image associated data in the second payload does not include one or more features of the unidentified object previously identified by the model in the authorized payload, the computing device 240 may refrain from performing the model update operation 276.

It should be understood that the inputs and/or outputs depicted in the signal diagram 235 are for ease of illustration, and may not represent and/or include every input/output and/or every component associated with the inputs/outputs. Moreover, a signal indicated in the signal diagram 235 as one signal may be comprised of multiple signals. For example, a payload depicted as being transmitted via a single transmission may be transmitted via multiple successive transmissions.

FIG. 3A depicts a block diagram 300 for generating an example authorized payload to update a model, according to some embodiments. The block diagram 300 includes a data capture device 305 (e.g., the indicia readers 100, 120; the data capture device 205), a server 315 (e.g., the host 210, the server 215, the computing device 240), and a network 320 (e.g., the network 220).

A User 302 of the data capture device 305 is a retail employee scanning soup cans with an updated label (updated soup cans 312) for inventory. The updated soup cans 312 are wrapped in an updated label that contains a barcode. Upon scanning each of the updated soup cans 312 (e.g., by activating a trigger button on the data capture device 305), the data capture device 305 captures one or more images of the updated soup can 312 comprising image data (e.g., capturing images 242). The data capture device 305 may generate the payload (e.g., generating the payload 246) including image associated data including a representation of at least a portion of the unidentified object. For example, the image associated data may include at least some of the captured images of the updated soup can 312, portions of the one or more images of the updated soup can 312 (e.g., images of a region of interest containing features of the updated soup can label), representations of the one or more images (e.g., transformations of the images/image data), etc.

The payload may further include an object identifier corresponding to the updated soup can 312. For example, the object identifier may be an image of the barcode, data associated with the decoded barcode, an electronic identifier (e.g., from an electronic tag associated with the item), and/or any other suitable object identifier. The object identifier (e.g., the barcode) may remain the same whether corresponding to the soup can with the previous label which the model is configured to identify, or whether corresponding to the updated soup can 312 the model is not configured to identify. Accordingly, the object identifier may inform the model and/or server 215 of what the updated soup can 312 (e.g., the unidentified object) of the payload may be when the model is not yet configured to identify the updated soup can 312 using the image associated data.

In some aspects, the payload may include a feature of the unidentified object (e.g., a feature indicated in the image associated data). For example, the payload may include features of the updated soup can label (e.g., label color, font, position of text/images on the label). The model may use the features (e.g., during an update operation, or once the model is updated) to identify the updated soup. In some aspects, the payload may include a feature of the object corresponding to the object identifier (e.g., features of the soup can with the previous label). For example, updating the model and/or the model identifying the updated soup can 312 may require at least one feature of the updated soup can label to match at least one feature of the previous soup can label, as discussed in further detail below with respect to ticket-switching.

The payload may further include an indication whether the payload is authorized or not authorized. In some aspects, if the payload does not include an indication it is authorized, the payload may then be considered unauthorized. Conversely, in other aspects if the payload does not contain an indication the payload is unauthorized, it may be considered as authorized.

In one aspect, the indication the payload is authorized may be based upon the data capture device 305. For example, the data capture device 305 may be configured to only generate authorize payloads. In one aspect, the payload may be authorized based upon the location of the data capture device 305 (e.g., a trusted location). The block diagram 300 includes a geofence 304 around the warehouse of the retailer where the User 302 conducts inventory, such that when the data capture device 305 generates a payload within the geofence 304, the payload is indicated as an authorized payload. In other examples, the trusted location may be based on a GPS coordinates, and/or any other suitable location information. In some aspects, the indication the payload is authorized may be based upon an operation of the data capture device 305. In one example, the User 302 performing inventory operations using the data capture device 305 may cause the data capture device 305 to generate the authorized payload. In another example, the data capture device 305 may perform an operation associated with updating a model (e.g., the model 230) such as capturing images of a product with updated packaging which are used to update the model to recognize the product with the updated packaging during customer checkout.

In some aspects, the payload is indicated as authorized based on the user of the data capture device 305. For example, the User 302 may have an employee identification badge that includes a QR code 306 that identifies the User 302. The User 302 may scan the QR code 306 with the data capture device 305 before performing inventory, and based upon identifying the User 302 via the QR code 306, the data capture device 305 may generate authorized payloads. In some aspects, the user may provide an input to the data capture device 305 (e.g., providing an input via a user interface of the data capture device 305) that authorizes payloads of the data capture device 305.

In some aspects, the payload is indicated as authorized or an authorization element in the image associated data. For example, a code or marking on the updated label of the updated soup can 312 can indicate that the label is an updated label. The code and/or marking may include extra bars on the barcode, a digital watermark detectable by an imager and substantially invisible to a human eye, encodings or other features of the barcode (e.g., features associated with a GS1 standard) that indicate the package update (e.g., a date of the update), a revision number of the updated label, etc.

The data capture device 305 may transmit the payload to the server 315 via the network 320. In response to the payload being authorized, the server 315 may perform a model update operation, and in response to the payload not being authorized, the server 315 may refrain from performing the model update operation.

In some aspects, the model update operation includes storing at least the portion of the image associated data on a memory (e.g., the memory 204) as model update data. The memory may be a memory of the server 315 or any other suitable device (e.g., the host 210, a database, etc.). The model update data may be used to update the model to recognize the updated soup can 312 as the same product as the soup can with the previous label.

In some aspects, the model update operation includes creating an association between the object identifier (e.g., the barcode on the updated soup can 312) and the image data and/or image associated data. The model may be updated to recognize the updated soup can 312 as the same product as the product associated with the updated soup can barcode.

In some aspects, the model update operation includes refraining from performing a ticket-switching operation that is triggered by a subsequent payload associated with the unidentified object. For example, if the server 315 receives a second payload from a data capture device 305 based on a scan of the updated soup can 312 during checkout, the second payload would not be flagged as a ticket-switch as described earlier.

In some aspects, ticket-switching detection could still be used even while the model is being updated by verifying that one or more features/details appearing on the updated object (e.g., around the barcode) are unchanged from the previous object known to the model. In such an aspect, the system may continue to determine an occurrence of a ticket-switching event if there is not a match between features/details of the updated and previous items and/or if the updated object is substantially different from the previous object in a region of the product packaging (e.g., a label).

FIG. 3B depicts an example updated packaging that has not been stored within the model, more specifically the updated label of the updated soup can 312, according to some embodiments. In one example, the payload includes associated image data of the region of interest (ROI) 360 of the updated label 350. The ROI 360 includes the barcode 362, the tip of the spoon 364, and text 366 of manufacturing information, any of which may be considered features of the updated label 350. The server 315 may receive the payload including associated image data of the ROI 360, and process the associated image data with the model in an attempt to identify the updated soup can 312 based upon features of the updated label 350. The barcode 362 and the text 366 may be the same as the previous label of the soup can the model is configured to identify, however the graphic of the bowl of soup that includes the tip of the spoon 364 may be a new image only included on the updated label 350 and not included on the previous label of the soup can. Accordingly, the model may determine based upon the barcode 362 and/or the text 366 that the updated label 350 is similar to the previous soup can label. Based on such a determination of similarity between features of the updated and previous label, the server 315 and/or model may determine (i) ticket-switching is not occurring even though the model does not recognize the updated label 350 as the soup can it is already configured to identify; and/or (ii) that the associated image data in the payload is trusted and may be used to update the model to identify the updated soup can as the same product as the soup can it is already configured to identify (and is associated with the barcode 362 of the updated label 350).

In a second example, the payload may include associated image data of the ROI 370 rather than the ROI 360. The ROI 370 includes the tip of the spoon 364 and not the barcode 362 nor the text 366. As the tip of the spoon 364 is not a feature included on the previous label of the soup can, the model may determine the payload is a result of a ticket-switching event and/or that the image of the ROI 370 is not to be used to update the model.

As the model is updated using associated image data of the updated label 350, additional features such as the tip of the spoon 364 may eventually be associated with the updated soup can 312 to update the model. For example, the model may receive a first payload with associated image data of the ROI 360. As the barcode 362 and text 366 are known features of the previous soup can label, the model may consider the payload trusted and/or otherwise associate all features in the associated image data of the ROI 360 of (which includes the tip of the spoon 364) with the known soup can. Thus, when receiving a second payload including the ROI 370, the model will have already associated the tip of the spoon 364 as a feature of the updated soup can 312, and be able to identify the updated soup 312 based upon the ROI 370 that includes the tip of the spoon 364 and not the barcode 362 or the text 366. In at least some aspects, in order to prevent false determination of ticket-switching, ticket-switching detection may be disabled until the update of the model is fully completed or completed beyond a certain threshold.

In embodiments, the server 315 may receive an unauthorized payload from the data capture device 305. In some implementations, the model may determine, based upon an image of the updated label 350 in the unauthorized payload, that the updated soup can label 350 is not identified as the soup can corresponding to the barcode 362. Being that the payload is both not authorized and includes associated image data of an unidentified object that does not correspond with the object identifier, the server 315 may determine the payload is a result of ticket-switching. However, rather than trigger a ticket-switch operation in response, the server 315 may transmit (e.g., transmission 256) information to the data capture device 305 (e.g., via the network 320) indicating the payload is not authorized, such as an electronic a message, notification, alert, etc. Responsive to receiving the information, the data capture device 305 may generate information to authorize the payload (e.g., the authorization 258). For example, the User 302 may indicate on a user interface of the data capture device 305 that the payload is authorized in response to receiving the information from the server 315. The data capture device 305 may provide (e.g., via the network 320) the information to authorize the payload to the server 315 (e.g., the transmission 260 authorizing the payload).

The data capture device 305 may capture supplementary image data (e.g., capturing supplemental images 262) comprising one or more supplemental images of at least the portion of the updated soup can 312, for example images of the updated soup can 312 at various angles, orientations, and the like. The supplementary images may provide different depictions of the updated soup can 312 used for updating the model to identify the updated soup can 312 at various angles, orientations, etc. In at least some aspects, capturing supplemental images may be in response to the server 315 performing the model update operation after receiving an authorized payload. The data capture device 305 may store the supplemental image data in memory (e.g., for performing a model update operation by a suitable device, transmit (e.g., the transmission 264) the supplemental image data to the server 315 (e.g., via the network 320) to conduct a model update operation, etc.

In some embodiments, the data capture device 305 may capture one or more additional images (e.g., capture additional images 266) of the updated soup can 312, and analyze the additional image data to generate a second payload (e.g., generating the second payload 268). The data capture device 305 may transmit (e.g., the transmission 270) the second payload to the server 315. Responsive receiving to the second payload, the server 315 may determine (e.g., the determination 272) whether it previously received an authorized payload associated with the updated soup can 312.

If the server 315 determines it previously did not receive an authorized payload associated with the updated soup can 312, it may determine (e.g., the determination 250) the second payload is authorized and perform the model update operation using the second payload, or determine the second payload is not authorized and refrain from performing the model update operation using the second payload.

If the server 315 determines it did previously receive an authorized payload associated with the updated soup can 312, the server 315 may determine (e.g., the determination 274) whether at least one of the additional images of the updated soup can 312 in the second payload includes one or more features of the updated soup can 312 previously identified by the model in the previous authorized payload. If at least one of the additional images of the updated soup can 312 in the second payload includes one or more features of the updated soup can 312 previously identified by the model in the previous authorized payload, the server 315 may perform a model update operation (e.g., the model update operation 276) using the second payload. If at least one of the additional images of the updated soup can 312 in the second payload does not include one or more features of the updated soup can 312 previously identified by the model in the previous authorized payload, the server 315 may refrain from performing the model update operation (e.g., refraining from the model update operation 252) using the second payload.

It should be understood that the block diagram 300 may include additional, fewer, and/or alternate components, and may be configured to perform additional, fewer, or alternate actions, including components/actions described herein. For example, a first data capture device 305A (e.g., a handheld indicia reader 120) may generate the first payload of the updated soup can 312 during inventory, and a second data capture device 305B (e.g., a bioptic indicia reader 100) may generate the second payload of the updated soup can 312 during a customer checkout. Similarly, the server 315 may perform a first model update operation using the first payload, and a POS (e.g., the host 210) may perform a second model update operation using the second payload.

FIG. 4A depicts a flow diagram of an example method 400 for generating an authorized payload to update a model configured to identify at least one object, according to some embodiments. In at least some embodiments, the method 400 may be performed by the computing environment 200 and/or generate one or more signals of the signal diagram 235.

The method 400 may include capturing, by a data capture device (e.g., the data capture device 305), one or more images comprising image data of an unidentified object (e.g., the updated soup can 312) within a field of view of the data capture device (block 410). In at least some implementations of the method 400, the at least one object the model is configured to identify with a predetermined level of confidence does not include the unidentified object. In at least some implementations, the unidentified object is one object, of the at least one object, the model is configured to identify, with updated packaging.

The method 400 may include generating, by analyzing the image data, a payload (block 420). The payload (e.g., the payload 246) may include (i) image associated data including a representation of at least a portion of the unidentified object, (ii) an object identifier corresponding to an object of the at least one object the model is configured to identify, and (iii) an indication the payload is at least one of authorized or not authorized. The object identifier may be based upon one or more of an electronic identifier or a visual identifier included in at least the portion of image. In at least some embodiments, the indication the payload is authorized may be based upon one or more of: the data capture device, a location of data capture device, an operation of the data capture device, a user of the data capture device, a user input at the data capture device, or an authorization element in the image associated data. The payload may include a feature of the unidentified object and/or a feature of the object corresponding to the object identifier.

The method 400 may include responsive to the payload being authorized, performing a model update operation (block 430). The model update operation (e.g., the model update operation 254) may include one or more of: storing at least a portion of the image associated data on a memory as model update data, updating the model using at least the portion of the image associated data to identify the unidentified object as the object corresponding to the object identifier, creating an association between the object identifier and the image data and/or image associated data, or refraining from performing for at least a portion of time one or more operations associated with ticket-switching that is triggered by a subsequent payload associated with the unidentified object. In at least some aspects, the portion of time is associated with the amount of time for the model to learn to identify the object.

The method 400 may include, responsive to the payload not being authorized, refraining from performing the model update operation (block 440).

It at least some aspects, the method 400 may include determining a region of interest in the one or more images, and cropping the one or more images to include the region of interest.

It at least some aspects, the method 400 may include (i) receiving information indicating the payload is not authorized; (ii) responsive to receiving the information, generating information to authorize the payload; and (iii) providing, to a computing device, the information to authorize the payload. Receiving the information may be responsive to the model determining, based upon the payload, that the unidentified object is not identified as the object corresponding to the object identifier.

It at least some aspects, the method 400 may include (i) capturing, by the data capture device, one or more additional images of the unidentified object; (ii) generating a second payload based upon the one or more additional images; and (iii) based upon the second payload and previously receiving the authorized payload associated with the unidentified object, perform the model update operation. The model may further be configured to, responsive to determining second image associated data in the second payload does not include one or more features of the unidentified object previously identified by the model in the authorized payload, refrain from performing the model update operation.

It at least some aspects, the method 400 may include, responsive to performing the model update operation based upon the authorized payload, capturing, by the data capture device, supplemental image data of the unidentified object used to perform a subsequent model update operation.

FIG. 4B depicts a flow diagram of an example method 450 for updating a model based upon an authorized payload, according to some embodiments. In at least some embodiments, the method 450 may be performed by the computing environment 200 and/or generate one or more signals of the signal diagram 235.

The method 450 may include receiving a payload (block 460). The payload may include (i) image associated data including a representation of at least a portion of an unidentified object, the image associated data generated based upon image data captured by a data capture device (e.g., the data capture device 205), (ii) an object identifier corresponding to an object, of one or more objects, the model is configured to identify, and (iii) an indication the payload is at least one of authorized or not authorized. The object identifier may be based upon one or more of an electronic identifier or a visual identifier included in at least the portion of image. The indication the payload is authorized may be based upon one or more of: a data capture device, a location of data capture device, an operation of the data capture device, a user of the data capture device, a user input at the data capture device, or an authorization element in the image associated data.

The method 450 may include, responsive to the payload indicating the payload is authorized, performing a model update operation (block 470). The model update operation may include one or more of: storing at least a portion of the image associated data on a memory as model update data, updating the model using at least the portion of the image associated data to identify the unidentified object as the object corresponding to the object identifier, creating an association between the object identifier and the image data and/or image associated data, or refraining from performing for at least a portion of time one or more operations associated with ticket-switching triggered by receiving a subsequent payload associated with the unidentified object.

The method 450 may include, responsive to the payload indicating the payload is not authorized, refraining from performing the model update operation (block 480).

In at least some aspects of the method 450, the unidentified object is an update of one object, of the one or more objects, the model is configured to identify. In such an aspect, the update of the one object includes updated packaging. In such an aspect, the method 450 may further include updating the model to identify the unidentified object and the one object.

In at least some aspects, the method 450 may include (i) generating information indicating the payload is not authorized; (ii) providing the information to the data capture device; (iii) receiving, from the data capture device, information to authorize the payload; and (iv) authorizing the payload.

In at least some aspects, the method 450 may include providing the image associated data in the payload to the model, and determining, by the model based upon the image associated data in the payload, the unidentified object is not identified as the object corresponding to the object identifier, wherein generating the information indicating the payload is not authorized is in response to determining the unidentified object is not identified as the object.

In at least some aspects, the method 450 may include receiving a second payload including second image associated data including a representation of at least the portion of the unidentified object, and responsive receiving to the second payload and previously receiving the authorized payload associated with the unidentified object, performing the model update operation using the second image associated data. In such aspects, the method 450 may further include, responsive to the model determining the second image associated data in the second payload does not include one or more features of the unidentified object previously identified by the model in the authorized payload, refraining from performing the model update operation.

In at least some aspects, the method 450 may include, responsive to performing the model update operation based upon receiving the authorized payload, receiving supplemental image associated data including a representation of at least the portion of the unidentified object, and performing one or more of: storing the supplemental image associated data as model update data, or updating the model using the supplemental image associated data.

In at least some aspects of the method 450, a first computing device may update the model, and a second computing device may operate the model; or a first computing device may update the model and operate the model.

It should be understood that not all blocks of the example flowcharts of FIGS. 4A and/or 4B of methods 400 and/or 450 respectively are required to be performed.

Additionally, the example methods 400 and/or 450 may include additional, less, or alternate steps, including those discussed elsewhere herein.

It will be understood that the foregoing represents one potential implementation, and that other implementations may be envisioned.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises. a”, “has. a”, “includes. a”, “contains. a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method for generating an authorized payload to update a model configured to identify at least one object, the method comprising:
capturing, by a data capture device, one or more images comprising image data of an unidentified object within a field of view of the data capture device, wherein the at least one object the model is configured to identify with a predetermined level of confidence does not include the unidentified object;
generating, based on analyzing the image data, a payload including:
image associated data including a representation of at least a portion of the unidentified object,
an object identifier corresponding to an object of the at least one object the model is configured to identify, and
an indication the payload is at least one of authorized or not authorized;
responsive to the payload being authorized, performing a model update operation; and
responsive to the payload not being authorized, refraining from performing the model update operation.

2. The method of claim 1, wherein the object identifier is based upon one or more of an electronic identifier or a visual identifier included in at least the portion of image.

3. The method of claim 1, wherein the indication the payload is authorized is based upon one or more of: the data capture device, a location of data capture device, an operation of the data capture device, a user of the data capture device, a user input at the data capture device, or an authorization element in the image associated data.

4. The method of claim 1, wherein the model update operation includes one or more of: storing at least a portion of the image associated data on a memory as model update data, updating the model using at least the portion of the image associated data to identify the unidentified object as the object corresponding to the object identifier, creating an association between the object identifier and the image data and/or image associated data, or refraining from performing for at least a portion of time one or more operations associated with ticket-switching that is triggered by a subsequent payload associated with the unidentified object.

5. The method of claim 1, wherein the payload includes one or more of: a feature of the unidentified object or a feature of the object corresponding to the object identifier.

6. The method of claim 1, wherein the unidentified object is one object, of the at least one object, the model is configured to identify, with updated packaging.

7. The method of claim 1, further comprising:
determining a region of interest in the one or more images; and
cropping the one or more images to include the region of interest.

8. The method of claim 1, further comprising:
receiving information indicating the payload is not authorized;
responsive to receiving the information, generating information to authorize the payload; and
providing, to a computing device, the information to authorize the payload.

9. The method of claim 8, wherein:
receiving the information is responsive to the model determining, based upon the payload, that the unidentified object is not identified as the object corresponding to the object identifier.

10. The method of claim 1, further comprising:
capturing, by the data capture device, one or more additional images of the unidentified object;
generating a second payload based upon the one or more additional images; and
based upon the second payload and previously receiving the authorized payload associated with the unidentified object, perform the model update operation.

11. The method of claim 10, wherein the model is further configured to:
responsive to determining second image associated data in the second payload does not include one or more features of the unidentified object previously identified by the model in the authorized payload, refrain from performing the model update operation.

12. The method of claim 1, further comprising:
responsive to performing the model update operation based upon the authorized payload, capturing, by the data capture device, supplemental image data of the unidentified object used to perform a subsequent model update operation.

13. A system for generating an authorized payload to update a model configured to identify at least one object, the system comprising:
a data capture device having a field of view and configured to capture one or more images of the field of view;
one or more processors; and
a memory storing instructions that, when executed by the one or more processors, cause the one or more processors to:
capture the one or more images comprising image data of an unidentified object within the field of view, wherein the at least one object the model is configured to identify with a predetermined level of confidence does not include the unidentified object;
generate, based on analyzing the image data, a payload including:
image associated data including a representation of at least a portion of the unidentified object,
an object identifier corresponding to an object, of the at least one object the model is configured to identify, and
an indication the payload is at least one of authorized or not authorized;
responsive to the payload being authorized, perform a model update operation; and
responsive to the payload not being authorized, refrain from performing the model update operation.

14. The system of claim 13, wherein the object identifier is based upon one or more of an electronic identifier or a visual identifier included in at least the portion of image.

15. The system of claim 13, wherein the indication the payload is authorized is based upon one or more of: the data capture device, a location of data capture device, an operation of the data capture device, a user of the data capture device, a user input at the data capture device, or an authorization element in the image associated data.

16. The system of claim 13, wherein the model update operation includes one or more of: storing at least a portion of the image associated data on a memory as model update data, updating the model using at least the portion of the image associated data to identify the unidentified object as the object corresponding to the object identifier, creating an association between the object identifier and the image data and/or image associated data, or refraining from performing for at least a portion of time one or more operations associated with ticket-switching triggered by a subsequent payload associated with the unidentified object.

17. The system of claim 13, wherein the payload includes one or more of: a feature of the unidentified object or a feature of the object corresponding to the object identifier.

18. The system of claim 13, wherein the unidentified object is one object, of the at least one object, the model is configured to identify, with updated packaging.

19. The system of claim 13, further comprising instructions that, when executed, cause the one or more processors to:
determine a region of interest in the one or more images; and
crop the one or more images to include the region of interest.

20. The system of claim 13, further comprising instructions that, when executed, cause the one or more processors to:
receive information indicating the payload is not authorized;
responsive to receiving the information, generate information to authorize the payload; and
provide, to a computing device, the information to authorize the payload.

21. The system of claim 20, wherein:
to receive the information is responsive to the model determining, based upon the payload, that the unidentified object is not identified as the object corresponding to the object identifier.

22. The system of claim 13, further comprising instructions that, when executed, cause the one or more processors to:
capture, by the data capture device, one or more additional images of the unidentified object;
generate a second payload based upon the one or more additional images; and
based upon the second payload and previously receiving the authorized payload associated with the unidentified object, perform the model update operation.

23. The system of claim 22, wherein the model is further configured to:
responsive to determining second associated image data in the second payload does not include one or more features of the unidentified object previously identified by the model in the authorized payload, refrain from performing the model update operation.

24. The system of claim 13, further comprising instruction that, when executed, cause the one or more processors to:
responsive to performing the model update operation based upon the authorized payload, capture, by the data capture device, supplemental image data of the unidentified object used to perform a subsequent model update operation.

25-48. (canceled)
